(19) United States
(12) Patent Application Publication
(10) Pub. No.: US 2009/0171786 A1
(43) Pub. Date: Jul. 2, 2009

(54) ADVERTISEMENT APPARATUS WITH RFID TAG

(75) Inventors: Chie-Chung Kuo, Keelung City (TW); Po-Kuang Chang, Taoyuan County (TW); Jeng-Nan Wu, Taoyuan County (TW); Min-Kao Hong, Taichung City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/101,940

(22) Filed: Apr. 11, 2008

(30) Foreign Application Priority Data
Dec. 27, 2007 (TW) 096150484

(51) Int. Cl. G06Q 30/00

(52) U.S. Cl. 705/14

(57) ABSTRACT

An advertisement apparatus including a controller, a display panel, a reader and a tag is provided. The controller is suitable for receiving advertising content information and tag information corresponding to the advertising information simultaneously. The display panel is suitable for receiving the advertising information from the controller and displaying the same. The reader is suitable for receiving the tag information from the controller and writing the same to the tag. Thus, a user may read the tag information stored in the tag via a portable device to get the message related to the advertising information.

### FIELD OF THE INVENTION

The present invention relates to an advertisement apparatus, and more particularly, to an advertisement apparatus with radio frequency identification (RFID) tag capable of dynamically updating advertising content information and tag information corresponded to the advertising content information in a manner that an interested user is enabled to have instant access to the tag information so as to download the message related to the advertising content information for browsing.

### BACKGROUND OF THE INVENTION

With rapid advance of technology, more and more innovative types of advertising are coming into existence. Except for those common advertising media such as television and radio broadcasting, many innovated advertisement apparatuses using other media including billboards, LCD screens, interactive kiosk and digital shop window are becoming popular and thus used by manufacturing for marketing their products and services to their potential consumers.

Please refer to FIG. 1, which shows a conventional advertisement apparatus. In FIG. 1, the advertisement apparatus 100 is a device capable of being fixed to a wall for facilitating passing pedestrians to browse, which is comprised of a billboard 110 and a tag 120. The billboard 110 is painted with a specific advertising content while enabling the tag 120 to store a tag information corresponding to the specific advertising content, so that when a potential customer is interested in the advertisement and wants to know more about it, the interested customer can use his/her cellular phone 50 that is embedded with a reader module 52 to read the tag information stored in the tag 120.

However, it is noted that the advertising content of the abovementioned advertisement apparatus 100 is usually difficult or even impossible to be updated in real time that it is usually being updated probably every few other months, and moreover, such advertisement apparatus 100 can be used for marketing only one advertising content in one advertising cycle so that its usage efficiency is poor.

In addition, as most those conventional advertisement apparatuses use Bluetooth device for communication which requires to go through a very complex configuration before it can be used for two-way communication, such conventional advertisement apparatuses may not be considered as user friendly. Not to mention that there are still difficulties for enabling communication between Bluetooth devices of different manufacturers since the Bluetooth communication protocol is not yet been standardized.

### SUMMARY OF THE INVENTION

The object of the present invention is to provide an advertisement apparatus with radio frequency identification (RFID) tag which has a reader built therein to be used for updating the tag information of its tag in a real time manner and thus enabling a user to instantly get the message relating to the advertising content of the tag information.

It is another object of the invention to provide an advertisement apparatus, capable of emulating functions of radio frequency identification (RFID) tag by circuit design in a manner that it is able to update tag information in real time through a communication device and thus enables user to instantly get the message relating to the advertising content of the tag information.

To achieve the above objectives, the present invention provides an advertisement apparatus, which comprises: a controller, for simultaneously receiving advertising content information and tag information corresponding to the advertising information; a display panel, for receiving the advertising content information from the controller and displaying the same; a tag; and a reader, for receiving the tag information from the controller and writing the same to the tag.

To achieve the above objectives, the present invention further provides an advertisement apparatus, which comprises: a controller, for simultaneously receiving advertising content information and tag information corresponding to the advertising information; a display panel, for receiving the advertising content information from the controller and displaying the same; and a tag emulator, being a circuit configured for emulating functions of a tag to be adapted for communicating with a portable device and being enabled to receive tag information from the controller while storing the same therein.

In an exemplary embodiment of the invention, the tag can be an active tag or a passive tag.

In an exemplary embodiment of the invention, the tag information includes a tag ID, a link parameter and a position ID.

In an exemplary embodiment of the invention, the receiving of the advertising content information and the tag information by the controller can be achieved by a means selected from the group consisting of a digital broadcast, a wireless point-to-point transmission, a physical memory and Internet.

In an exemplary embodiment of the invention, the reader is substantially a radio frequency identification (RFID) reader and the tag is a RFID tag, by which the tag is able to communicate with the reader by the use of a radio wave selected from the group consisting of: an ultra high frequency (UHF) radio wave ranged between 860 MHz and 928 MHz, a low frequency radio wave ranged between 15 MHz and 134 MHz, a 13.56 MHz high frequency radio wave, a 433 MHz ultra high frequency radio wave and a 2.4 GHz micro wave.

In an exemplary embodiment of the invention, the tag emulator further comprises: a micro-controller, a power control, a modulator, a demodulator and an antenna; in which all the power control, the modulator and the demodulator are connected to the micro-controller while the antenna is connected to the modulator and the demodulator. Moreover, the micro-controller further comprises: an encoder and a decoder, which are connected respectively to the modulator and the demodulator.

In an exemplary embodiment of the invention, the tag information is enabled to be accessed by a user using a portable device configured with a communication unit and a reader module, in which the communication unit is adapted for connecting with the Internet and the reader module is adapted for accessing the tag information registered in the tag or the tag emulator while transmitting the accessed tag information to the communication unit. In addition, the communication unit is enabled to download messages relating to the advertising content information from the Internet.

In an exemplary embodiment of the invention, the communication unit is enabled to connected with a data server by the use of an interface, which can be a Bluetooth interface or the like.

To sum up, when the advertising apparatus of the invention is updated for enabling its display panel to display a new advertising content information, its tag information registered in its tag or tag emulator is going to be updated simultaneously for synchronizing the same with the new advertising content information; thereby, when a user is interested by the displayed advertising content information and wants to know more about it, the user is able to operate a portable device to access the corresponding tag information and thus use the link parameter of the tag information to connect to the Internet or other data server for downloading messages relating to the advertising content information.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional advertisement apparatus.

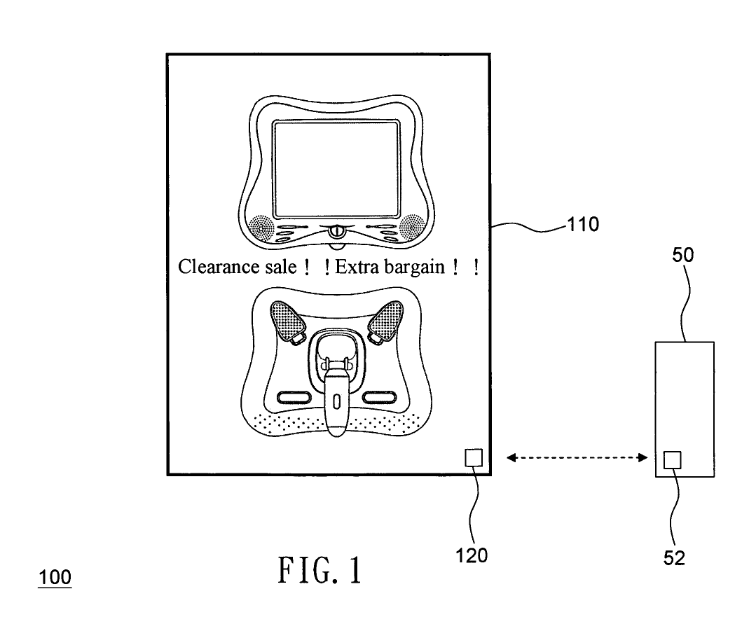

FIG. 2 is a block diagram illustrating an advertisement apparatus according to an exemplary embodiment of the invention.

FIG. 3 is a block diagram illustrating an advertisement apparatus according to another exemplary embodiment of the invention.

FIG. 3A is a block diagram depicting the tag emulator of FIG. 3.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

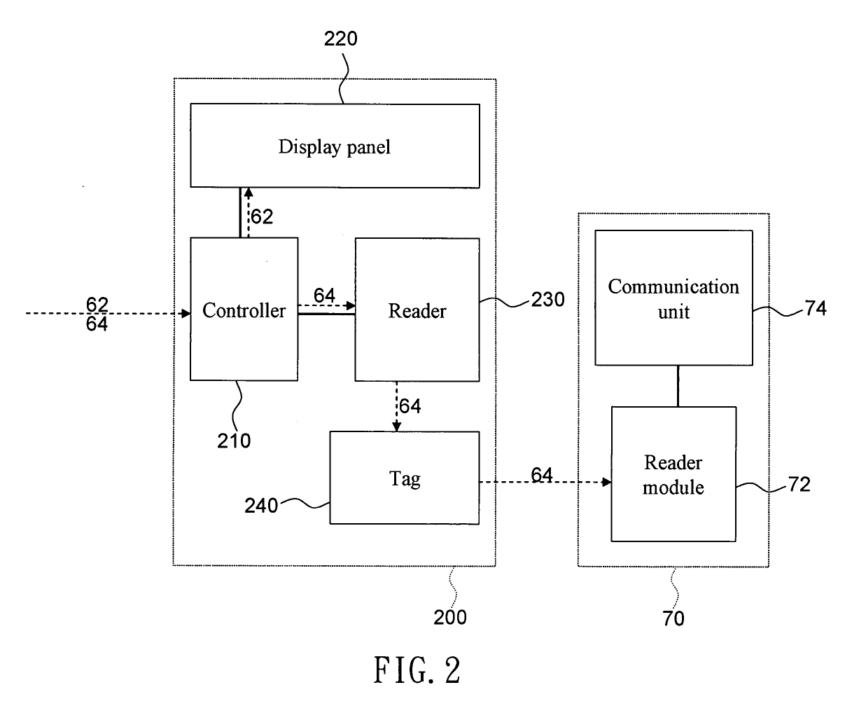

Please refer to FIG. 2, which is a block diagram illustrating an advertisement apparatus according to an exemplary embodiment of the invention. In FIG. 2, the advertisement apparatus 200 includes a controller 210, a display panel 220, a reader 230, and a tag 240, in which the display panel 220 and the reader 230 are connected to the controller 210. The controller 210 is suitable for simultaneously receiving advertising content information 62, in which the advertising content information 62 is an expressive promotion of ideas intended by the owner of the advertisement to communicate with his/her potential customer that can be a product marketing, a activity introduction or a movie promotion. The tag information 64 is designed to correspond to the advertising content information 62.

It is noted that as the advertising content information 62 is being updated continuously while each specific advertising content information is configured to correspond to its specific tag information 64 in a one-to-one manner, the controller 210 will receive a pair of the advertising content information 62 and the tag information 64 at the same time.

After the receiving, the controller 210 will transmit respective the advertising content information 62 and the tag information 64 to the display panel 220 and the reader 230 so that the display panel can display the advertising content information 62 while the reader 230 can write the tag information 64 into the tag 240. Thereby, when the advertising apparatus 200 of the invention is updated for enabling its display panel 220 to display a new advertising content information 62, its tag information 64 registered in its tag 240 is going to be updated simultaneously for synchronizing the same with the new advertising content information 62.

For clarity, the types of the advertisement apparatus 200 of the invention can be various. For instance, the advertisement apparatus 200 can be a poster advertising billboard, a LCD screens, an interactive kiosk, a large-sized outdoor billboard, a tour information station, a shopping information station or a digital shop window, but is not limited thereby. Moreover, the advertisement apparatus 200 can be adapted as a household television set or be adapted as a TV shopping program so that its tag information 64 and the advertising content information 62 can be updated simultaneously when a program playing of the TV is breaking for commercials.

In addition, the advertising content information 62 displayed on the display panel 220 can be a static advertising or a dynamic advertising that is provide for the passing pedestrians to browse. When a user is interested by the displaying advertising content information 62 and wants to know more about it, the user is able to operate a portable device 70 to access the corresponding tag information 64 and thus obtain more detail commercial messages relating to the advertising content information 62. In detail, as the portable deice 70 is embedded with a reader module 72 adapted for accessing the tag information 64 registered in the tag 240, the user is able to download the accessed tag information 64 into his/her portable device 70 and thereby capable of obtaining more detail commercial messages relating to the advertising content information 62.

It is noted that there is no restriction to what can be included in the tag information 64. In an exemplary embodiment of the invention, the tag information 64 can include all the content in the advertising content information 62 and even attached with additional product specification and description relating to bargain price.

In an exemplary embodiment, the reader 230 and the tag 240 are substantially the so-called paired device in the radio frequency identification (RFID) industry. That is, the reader 230 is substantially a radio frequency identification (RFID) reader and the tag 240 is a RFID tag, by which the tag 240 is able to communicate with the reader 230 by the use of an ultra high frequency (UHF) radio wave ranged between 860 MHz and 928 MHz. It is noted that the reader module 72 can also communicate with the tag 240 by the same way.

It is noted that in addition to the aforesaid ultra high frequency (UHF) radio wave ranged between 860 MHz and 928 MHz, the tag 240 can also communicate with the reader module 72 or the reader 230 by the use of other radio wave selected from the group consisting of: a low frequency radio wave ranged between 9 MHz and 135 MHz, a 13.56 MHz high frequency radio wave, an ultra high frequency (UHF) radio wave ranged between 300 MHz and 1200 MHz and a 2.4 GHz micro wave. The communication distance between the tag 240 and the reader 230 is affected by the frequency of the radio wave used, which usually can be between a meter to a kilometer. Moreover, as the communication protocol used for the communication is different when the radio frequency used is different, those skilled in the art should selected a radio wave suitable to actual requirement for communication.

Since the transmission speed using the RFID technology is comparatively slower and can only carry less data, it is intended to further simplified the tag information 64 in the present invention so as to expedite the speed of the user acquiring the advertising content information 62. In other word, the present invention is characterized in that: it only utilize the fast connection feature of the RFID technology for triggering another communication interface which has faster transmission speed but will require a much complex linkage procedure to achieve connection between the reader and the tag. It is noted that such faster communication interface can be a WiFi interface, a Bluetooth interface or a GPRS interface, and so on.

In an exemplary embodiment of the invention, the tag information 64 includes a tag ID and a link parameter, in which the tag ID is an encoded number matching specifically to a specific advertising content information 62, and the link parameter is the Web address corresponding to the specific advertising content information 62. Thus, according to the tag ID and the link parameter, a user is able to browse the Internet for acquiring messages relating to the specific advertising content information 62. Furthermore, when the specific advertising content information 62 is a tour guide information, the tag information 64 can be configured for further comprising a position ID to be used for positioning a attraction point, a restaurant, an exhibition room or a specific location.

As shown in FIG. 2, the portable device 70 is further comprised of a communication unit 74, which is connected to the reader module 72 while being configured for Internet connection. When the reader module 72 obtain the tag information 64 from the tag 240, it is going to transmit the tag information 64 to the communication unit 74 for enabling the same to utilize the parameters registered in the tag information 64, such as the tag ID, the link parameter and the position ID, to load messages relating to the advertising content information 62 from the Internet. Nevertheless, instead of the downloading from Internet, the present invention is capable of connecting to other data serve through a Bluetooth or other interfaces without having to connect to Internet.

Moreover, the portable device 70 can be a cellular phone or a personal digital assistant (PDA). In addition, if the portable device 70 is designed to connected to the Internet through a base station, the portable device should be configured with an interfaced using a communication protocol selected from the group consisting: WiFi, Wi-Max, Bluetooth, General Packet Radio Service (GPRS), Global System for Mobile Communication (GSM), and the like, by which it is able to communicate with the base station. As all the aforesaid interface are high speed interface that the time required for the user to obtain the messages relating to the advertising content information 64 can be greatly reduced.

From the above description, it is known that as the advertisement apparatus of the invention is able to perform a connection procedure by the use of the RFID technology along with the parameters in the tag information 64, the connection procedure is simplified and thus the time waste for establishing the connection is reduced by that the user is able to obtain the messages relating to the advertising content information 62 in a real time manner.

In detail, the messages relating to the advertising content information 62 includes product service, more detailed product description, discount code, on-line preview, location information, voice guide, or mobile shopping, etc. However, all the aforesaid messages have a limited period of validity so that the advertisement apparatus 200 of the invention is designed to update its advertising content information 62 in a dynamic manner so as to provide its user with real-time information. Furthermore, when the user had downloaded the message relating to his/her interested advertising content information 62, he/she is able to shop the item that he/she is interested on line that not only it can provide great convenience to the user, but also the marketing effect of the advertisement is greatly increased.

The receiving of the advertising content information 62 and the tag information 64 by the controller 210 can be achieved by a means selected from the group consisting of a digital broadcast, a wireless point-to-point transmission, a physical memory and Internet. As each advertising content information 62 playing on the display panel 220 will last only between a few minutes and several tens of minutes, the advertisement apparatus 200 is configured to play different advertising content information 62 continuously so that any person lingering in the neighborhood of the advertisement apparatus 200 might experience more than one advertisement. In addition, it is possible for the owner of the advertisement to select a playing time specifically for his/her potential customer so as to achieve optimal marketing effect.

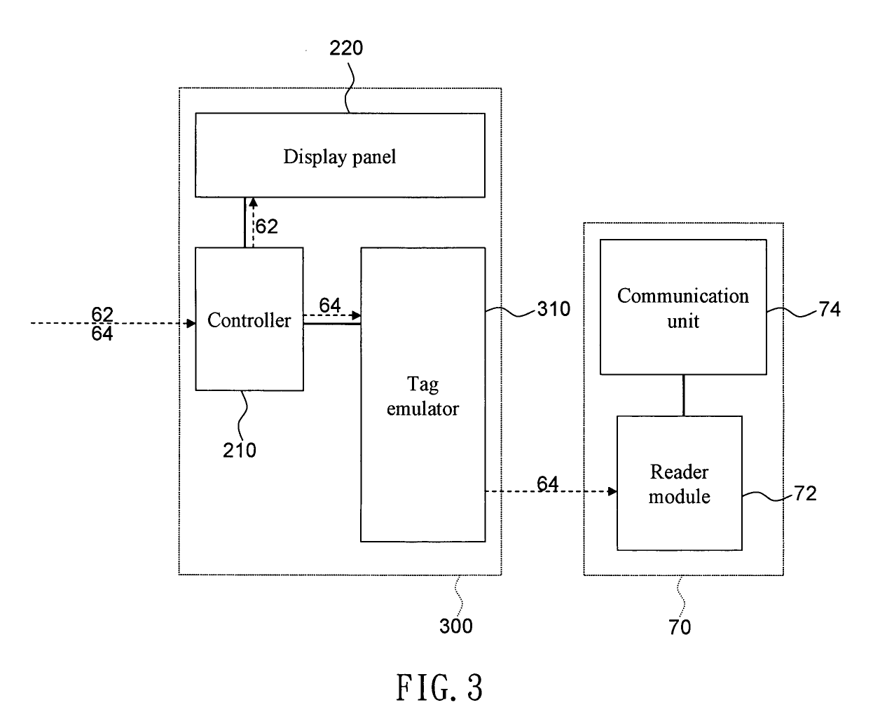

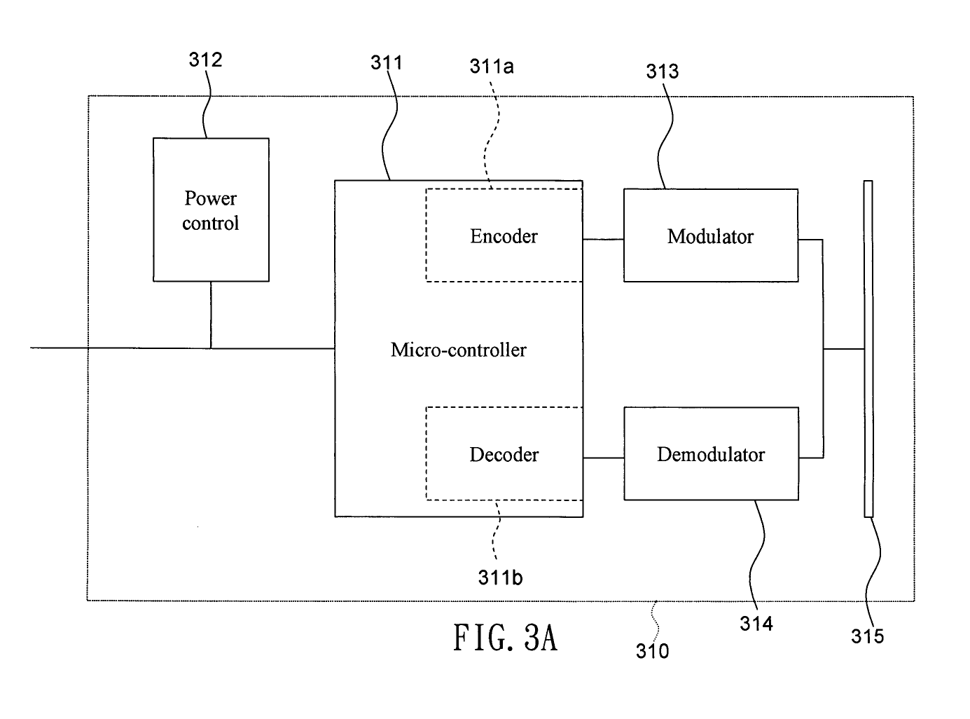

Please refer to FIG. 3, which is a block diagram illustrating an advertisement apparatus according to another exemplary embodiment of the invention. In FIG. 3, the advertisement apparatus 300 is almost the same as the foregoing advertisement apparatus 200, but is different only in that: the reader 230 and the tag 240 of the advertisement apparatus 200 is replaced by a tag emulator 310 which is also adapted for receiving and thus storing the tag information 64 from the controller 210. It is noted that the reader module 72 of the portable device 70 can also access the tag information 64 from the tag emulator 310.

Please refer to FIG. 3A, which is a block diagram depicting the tag emulator of FIG. 3. In FIG. 3A, the tag emulator 310 further comprises: a micro-controller 311, a power control 312, a modulator 313, a demodulator 314 and an antenna 315; in which all the power control 312, the modulator 313 and the demodulator 314 are connected to the micro-controller 311 while the antenna 315 is connected to the modulator 313 and the demodulator 314. Moreover, the micro-controller 311 further comprises: an encoder 311a and a decoder 311b, which are connected respectively to the modulator 313 and the demodulator 314.

The power control 312 is used for providing power to the micro-controller 311, and the micro-controller 311 is configured for receiving and storing tag information 64 from the controller 210. When the reader module 72 of the portable device 70 issue a signal requesting for accessing, the access signal will be received by the antenna 315 and then fed to the demodulator 314 and the decoder 311b for decoding, and eventually being transmitted to the micro-controller 311. After the decoded access signal is received by the micro-controller 311, it will be enabled to use the encoder 311a and the modulator 313 to encode the tag information 64 and then send the encoded tag information 64 to the antenna 315 where it is being transmitted in a radio wave form to the reader module 72.

In another word, the tag emulator 310 is designed to emulate functions of the tag, not matter it is an active tag or a passive tag, and used for communicating with the reader module 72 by a standardized communication protocol.

Moreover, the antenna 315 can be designed specifically to match with the RFID communication frequency and the application of the advertisement apparatus. For instance, when an UHF frequency is used, the antenna can be a Dipole antenna, a Monopole antenna, a microchip antenna, or a patch antenna, etc., and when the antenna 315 of the invention is used for receiving a HF or a LF frequency radio wave, the antenna 315 can be substantially an induction coil. In addition, the tag emulator 310 can adopt any communication protocol matching with the current standard RFID communication protocol or can be an independent system.

It is emphasized that the aforesaid tag emulator 310 is only used as illustration that it is not limited thereby. That is, any device that is able to store the tag information 64 and the same time can be accessed by the reader module 72 can be used as the tag emulator 310 of the invention. In addition, any modification upon the components of the tag emulator 310 by those skilled in the art should not be regarded as a departure from the spirit and scope of the invention.

To sum up, the advertisement apparatus of the invention has the following characteristics:
(1) when the advertising apparatus of the invention is updated for enabling its display panel to display a new advertising content information, its tag information registered in its tag or tag emulator is going to be updated simultaneously for synchronizing the same with the new advertising content information.
(2) when a user is interested by the displayed advertising content information and wants to know more about it, the user is able to operate a portable device to access the corresponding tag information and thus use the link parameter of the tag information to connect to the Internet or other data server for downloading messages relating to the advertising content information.
(3) when the user had downloaded the message relating to his/her interested advertising content information 62, he/she is able to shop the item that he/she is interested on line that not only it can provide great convenience to the user, but also the marketing effect of the advertisement is greatly increased.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An advertisement apparatus, comprising:
a controller, for simultaneously receiving advertising content information and tag information corresponding to the advertising information;
a display panel, for receiving the advertising content information from the controller and displaying the same;
a reader, for receiving the tag information from the controller; and
a tag, adapted for the reader to write the tag information into the same.

2. The advertisement apparatus of claim 1, wherein the tag information includes a tag ID and a link parameter.

3. The advertisement apparatus of claim 1, wherein the receiving of the advertising content information and the tag information by the controller is achieved by a means selected from the group consisting of a digital broadcast, a wireless point-to-point transmission, and the Internet.

4. The advertisement apparatus of claim 1, wherein the reader is a radio frequency identification (RFID) reader and the tag is a RFID tag.

5. The advertisement apparatus of claim 4, wherein the tag is enabled to communicate with the reader by the use of radio waves.

6. The advertisement apparatus of claim 1, wherein the advertising content information displayed on the display panel and the tag information stored in the tag are updated in a synchronized manner.

7. The advertisement apparatus of claim 1, wherein the tag information is accessible by a user using a portable device.

8. The advertisement apparatus of claim 7, wherein the portable device further comprises:
a communication unit, adapted for connecting to the Internet; and
a reader module, adapted for accessing the tag information registered in the tag while transmitting the accessed tag information to the communication unit.

9. The advertisement apparatus of claim 8, wherein the communication unit is enabled to download messages relating to the advertising content information from the Internet by the use of the tag information.

10. An advertisement apparatus, comprising:
a controller, for simultaneously receiving advertising content information and tag information corresponding to the advertising information;
a display panel, for receiving the advertising content information from the controller and displaying the same; and
a tag emulator, for receiving the tag information from the controller while storing the same therein.

11. The advertisement apparatus of claim 10, wherein the tag information includes a tag ID and a link parameter.

12. The advertisement apparatus of claim 10, wherein the receiving of the advertising content information and the tag information by the controller is achieved by a means selected from the group consisting of a digital broadcast, a wireless point-to-point transmission, and the Internet.

13. The advertisement apparatus of claim 10, wherein the tag emulator further comprises:
a micro-controller;
a power control, connected to the micro-controller;
a modulator, connected to the micro-controller;
a demodulator, connected to the micro-controller; and
an antenna, connected to the modulator and the demodulator.

14. The advertisement apparatus of claim 13, wherein micro-controller further comprises:
an encoder, connected to the modulator; and
a decoder, connected to the de modulator.

15. The advertisement apparatus of claim 10, wherein the advertising content information displayed on the display panel and the tag information stored in the tag are updated in a synchronization manner.

16. The advertisement apparatus of claim 10, wherein the tag information is accessible by a user using a portable device.

17. The advertisement apparatus of claim 16, wherein the portable device further comprises:
a communication unit, adapted for connecting to the Internet; and
a reader module, adapted for accessing the tag information registered in the tag while transmitting the accessed tag information to the communication unit.

18. The advertisement apparatus of claim 17, wherein the communication unit is enabled to download messages relating to the advertising content information from the Internet by the use of the tag information.
